(19) United States
(12) Patent Application Publication
(10) Pub. No.: US 2016/0320744 A1
(43) Pub. Date: Nov. 3, 2016

(54) DEVELOPING DEVICE INSERTION/EXTRACTION STRUCTURE AND IMAGE FORMING APPARATUS

(71) Applicant: FUJI XEROX CO., LTD., Tokyo (JP)

(72) Inventors: Atsushi FUNADA, Kanagawa (JP); Kiyohito HORII, Kanagawa (JP)

(73) Assignee: FUJI XEROX CO., LTD., Tokyo (JP)

(21) Appl. No.: 14/943,812

(22) Filed: Nov. 17, 2015

(30) Foreign Application Priority Data
Apr. 28, 2015 (JP) 2015-091771

(51) Int. Cl. G03G 15/04

(52) U.S. Cl. CPC G03G 21/1676

(57) ABSTRACT

Provided is a developing device insertion/extraction structure, including a developing device that is inserted to and extracted from an apparatus main body along a longitudinal direction, and includes a first restriction target section formed on a lower portion and a second restriction target section formed on a side portion, a first restricting section that is formed in the apparatus main body, and restricts displacement of the first restriction target section in a horizontal direction orthogonal to the longitudinal direction according to insertion or extraction of the developing device with respect to the apparatus main body, and a second restricting section that is formed in the apparatus main body, and restricts displacement of the second restriction target section in a vertical direction orthogonal to the longitudinal direction according to the insertion or the extraction of the developing device with respect to the apparatus main body.

### CROSS-REFERENCE TO RELATED APPLICATIONS

This application is based on and claims priority under 35 USC 119 from Japanese Patent Application No. 2015-091771 filed Apr. 28, 2015.

### BACKGROUND

### Technical Field

The present invention relates to a developing device insertion/extraction structure and an image forming apparatus.

### SUMMARY

When a developing device is inserted to or extracted from an apparatus main body along a longitudinal direction, there is a possibility that displacement of the developing device in a vertical direction is generated in addition to displacement of the developing device in a horizontal direction.

According to an aspect of the invention, there is provided a developing device insertion/extraction structure, including:

a developing device that is inserted to and extracted from an apparatus main body along a longitudinal direction, and includes a first restriction target section formed on a lower portion and a second restriction target section formed on a side portion;

a first restricting section that is formed in the apparatus main body, and restricts displacement of the first restriction target section in a horizontal direction orthogonal to the longitudinal direction according to insertion or extraction of the developing device with respect to the apparatus main body; and

a second restricting section that is formed in the apparatus main body, and restricts displacement of the second restriction target section in a vertical direction orthogonal to the longitudinal direction according to the insertion or the extraction of the developing device with respect to the apparatus main body.

### BRIEF DESCRIPTION OF THE DRAWINGS

Exemplary embodiments of the present invention will be described in detail based on the following figures, wherein:

FIG. 1 is a configuration view illustrating an image forming apparatus in which a developing device insertion/extraction structure according to a first exemplary embodiment is employed;

FIG. 2 is a side sectional view illustrating the developing device insertion/extraction structure which is employed in the image forming apparatus illustrated in FIG. 1;

FIG. 3 is a side sectional view illustrating the developing device which is used in the developing device insertion/extraction structure of illustrated in FIG. 2;

FIG. 4 is a perspective view illustrating the vicinity of a second convex portion and a second concave portion on a tip end side in an inserting direction of the developing device which is used in the developing device insertion/extraction structure illustrated in FIG. 2;

FIG. 5 is a perspective view illustrating the vicinity of a first convex portion and a first concave portion on the tip end side in the inserting direction of the developing device which is used in the developing device insertion/extraction structure illustrated in FIG. 2;

FIG. 6 is a side view illustrating a state where the developing device illustrated in FIG. 2 is pressed to an image holding member of an image forming apparatus main body;

FIG. 7 is a bottom view when a process of inserting the developing device illustrated in FIG. 2 to the image forming apparatus main body is viewed from below the developing device, and is a view illustrating a state immediately after the developing device starts to be inserted;

FIG. 8 is a bottom view when a process of inserting the developing device illustrated in FIG. 2 to the image forming apparatus main body is viewed from below the developing device, and is a view illustrating a state where the first convex portion of the developing device is inserted to the first concave portion of the image forming apparatus main body; and

FIG. 9 is a bottom view when a process of inserting the developing device illustrated in FIG. 2 to the image forming apparatus main body is viewed from below the developing device, and is a view illustrating a state where the second convex portion of the developing device is inserted to the second concave portion of the image forming apparatus main body.

### DETAILED DESCRIPTION

Hereinafter, an exemplary embodiment of the present invention will be described based on the drawings.

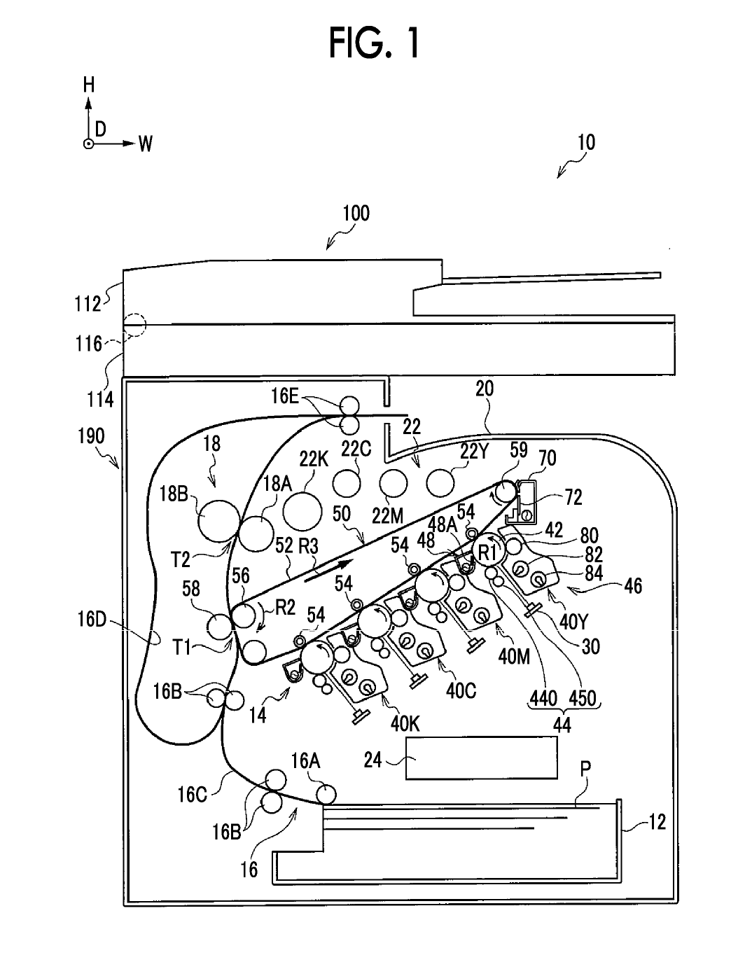

FIG. 1 is a view illustrating an example of a configuration of an image forming apparatus 10 in which a developing device insertion/extraction structure according to the exemplary embodiment is employed. In addition, in the following description, a direction illustrated by an arrow H in FIG. 1 is an apparatus height direction, and a direction illustrated by an arrow W is an apparatus width direction. In addition, a direction (illustrated by an arrow D) which is orthogonal to each of the apparatus height direction and the apparatus width direction is an apparatus depth direction.

As illustrated in FIG. 1, the image forming apparatus 10 includes an image reading section 100 and an image forming section 190. The image reading section 100 is part which outputs an image of an original document as read image data, and the image forming section 190 is apart which forms an image on a recording medium based on the image data.

The image reading section 100 includes a document transporting section 112 and a document reading section 114. In addition, the document transporting section 112 and the document reading section 114 are linked to each other by a linking section 116, and the document transporting section 112 may be opened and closed above the document reading section 114 around the linking section 116.

The image forming section 190 is configured to include a recording sheet accommodation section 12 which accommodates a recording sheet P as a recording medium, a toner image forming section 14, a transporting section 16, a fixing device 18, a discharging section 20, a replenish mechanism 22, and a control section 24.

The control section 24 is a part which controls operations of each section of the image forming apparatus 10, and will be described in detail later.

The toner image forming section 14 includes image forming units 40Y, 40M, 40C, and 40K, and a transfer unit 50. Here, yellow (Y), magenta (M), cyan (C), and black (K) are examples of toner colors.

In addition, each of image forming units 40Y, 40M, 40C, and 40K has a similar configuration to the others except for the toner used. Here, in FIG. 1, reference numerals of each section which configures the image forming units 40M, 40C, and 40K will be omitted.

The image forming unit 40Y includes an image holding member 42Y, a charging device 44Y, an exposure device 30Y, a developing device 46Y, and a removing device 48Y. Similarly, the image forming units 40M, 40C, and 40K include image holding members 42M, 42C, and 42K, charging devices 44M, 44C, and 44K, exposure devices 30M, 30C, and 30K, developing devices 46M, 46C, and 46K, and removing devices 48M, 48C, and 48K, corresponding to each color. In the following description, reference numerals Y, M, C, and K of the image forming units 40Y, 40M, 40C, and 40K, and each member which configures the image forming units, will be omitted unless it is necessary to distinguish the toner colors (Y, M, C, and K).

In each of the image forming units 40Y, 40M, 40C, and 40K, toner images of each color of yellow (Y), magenta (M), cyan (C), and black (K) are formed on an outer circumferential surface of each of the image holding members 42Y, 42M, 42C, and 42K. In addition, the image forming units 40Y, 40M, 40C, and 40K are disposed in a state where each image forming unit 40 is aligned being inclined with respect to the apparatus width direction as a whole.

An image holding member 42 has a function of holding the toner image developed by a developing device 46. The image holding member 42 is formed in a cylindrical shape, and is driven to rotate around an axis (arrow R1 direction) by a driving unit (not illustrated). The image holding member 42 has, for example, a base material made of aluminum, and a photosensitive layer (not illustrated) on which an undercoating layer, a charge generation layer, and a charge transfer layer are formed in this order on the base material.

A charging device 44 has a function of charging the outer circumferential surface of the image holding member 42. The charging device 44 is disposed along an axial direction (apparatus depth direction) of the image holding member 42. The charging device 44 includes a charging roll 440 and a cleaning roll 450. A necessary voltage for charging the outer circumferential surface of the image holding member 42 is applied to an axis (not illustrated) of the charging roll 440. The cleaning roll 450 removes impurities, such as a toner, an external additive, paper powder, or dust, which becomes attached to the outer circumferential surface of the charging roll 440.

An exposure device 30 has a function of forming a latent image on the outer circumferential surface of the image holding member 42 charged by the charging device 44. The exposure device 30 emits exposure light from a light-emitting diode array (not illustrated), for example, in accordance with the image data taken from an image signal processing section (not illustrated) which configures the control section 24. Here, the outer circumferential surface of the image holding member 42 charged by the charging device 44 is irradiated with the exposure light, and the exposure light forms the latent image on the outer circumferential surface.

The developing device 46 has a function of developing the latent image formed on the image holding member 42 as a toner image. The developing device 46 is disposed along the axial direction of the image holding member 42. The developing device 46 includes a toner supply member 80 which supplies the toner to the outer circumferential surface of the image holding member 42, two transporting members 82 which transport the developer including the toner and the carrier to the toner supply member 80, and a transporting member 84.

A removing device 48 has a function of removing the toner or the external additive which is not primarily transferred and remains on the outer circumferential surface of the image holding member 42 after the toner image formed on the outer circumferential surface of the image holding member 42 is primarily transferred to a transfer belt 52, from the outer circumferential surface of the image holding member 42. The removing device 48 is disposed along the axial direction of the image holding member 42, and includes a blade 48A which comes into contact with the outer circumferential surface of the image holding member 42.

The transfer unit 50 has a function of secondarily transferring the toner image to the recording sheet P after the toner images of each color developed on the outer circumferential surface of each image holding member 42 by each developing device 46 is primarily transferred. The transfer unit 50 includes the transfer belt 52, primary transfer rolls 54 of each color, a driving roll 56, and a secondary transfer roll 58.

The transfer belt 52 is an endless belt. The primary transfer roll 54 and the driving roll 56 are disposed to come into contact with an inner circumferential surface of the transfer belt 52. A posture of the transfer belt 52 is determined by four primary transfer rolls 54, the driving roll 56, and a tension imparting roll 59 which all come into contact with the inner circumferential surface thereof, and the transfer belt 52 is inclined with respect to the apparatus width direction when viewed from a front side. In addition, in the transfer unit 50, the outer circumferential surfaces of each image holding member 42 that configure each ring belt-shaped sheet material 40 aligned being inclined with respect to apparatus width direction come into contact with the outer circumferential surface which faces downward in the apparatus height direction. In addition, tension is imparted to the transfer belt 52 by the tension imparting roll 59 which is pressed by a pressing means (not illustrated).

The driving roll 56 is a long roll. A part of the outer circumferential surface of the driving roll 56 is wound around the inner circumferential surface of the transfer belt 52. In addition, when the driving roll 56 rotates (rotates in an arrow R2 direction) around the axis by a driving source (not illustrated), the driving roll 56 imparts a frictional force to the part wound around the outer circumferential surface of the driving roll 56 in the transfer belt 52. In addition, the driving roll 56 rotates the transfer belt 52 in an arrow R3 direction. The driving roll 56 has a function of rotating the transfer belt 52 as described above, and a function as a backup roll of the secondary transfer roll 58 which secondarily transfers the toner image that is primarily transferred to the outer circumferential surface of the transfer belt 52, to the recording sheet P as will be described later.

Each primary transfer roll 54 is disposed in a state of nipping the transfer belt 52, and being offset to a downstream side in the rotating direction (arrow R3 direction) of the transfer belt 52 with respect to a virtual straight line along the apparatus height direction that passes the axial centers of each image holding member 42. For this reason, the transfer belt 52 rotates in a state of being wound around the outer circumferential surface of the image holding member 42.

The primary transfer roll 54 primarily transfers the toner image formed on the outer circumferential surfaces of each of the image holding members 42Y, 42M, 42C, and 42K, to the outer circumferential surface of the transfer belt 52 as a primary transfer voltage is applied. In addition, the primary transfer voltage is a voltage applied to the primary transfer roll 54 during the primary transfer, and for example, is determined by the control section 24 based on values detected by a temperature sensor (not illustrated) or a humidity sensor (not illustrated) disposed in the image forming section 190.

The secondary transfer roll 58 is a long roll. The secondary transfer roll 58 is pressed by a pressing unit (not illustrated) when the image forming operation is performed, and forms a nipped portion (secondary transfer position T1) with the transfer belt 52. The secondary transfer roll 58 transports the toner image which is primarily transferred to the outer circumferential surface of the transfer belt 52 along a transporting path 16C which will be described later, and secondarily transfers the toner image to the recording sheet P which passes through the secondary transfer position T1, as a secondary transfer voltage is applied. In addition, the secondary transfer voltage is a voltage which is applied to the secondary transfer roll 58 during the secondary transfer, and is determined by the control section 24 similarly to the case of the primary transfer voltage.

A cleaning device 70 has a function of removing the toner or the external additive which is not secondarily transferred and remains on the outer circumferential surface of the transfer belt 52 after the toner image which is primarily transferred to the outer circumferential surface of the transfer belt 52 is secondarily transferred to the recording sheet P, from the outer circumferential surface of the transfer belt 52 by a scraping section 72. The cleaning device 70 is disposed nipping the transfer belt 52 along the axial direction of the tension imparting roll 59.

Replenish mechanisms 22Y, 22M, 22C, and 22K have a function of replenishing the developer to the developing devices 46Y, 46M, 46C, and 46K.

The transporting section 16 has a function of transporting the recording sheet P accommodated in the recording sheet accommodation section 12 to the discharging section 20 which will be described later. The transporting section 16 includes a sending roll 16A, plural transporting roll pairs 16B, a reversal transporting section 16D, and an exit roll 16E which will be described later. The sending roll 16A sends out the recording sheet P accommodated in the recording sheet accommodation section 12 to further from the downstream side than the sending roll 16A in a transporting direction of the recording sheet P. The plural transporting roll pairs 16B are disposed along the transporting path 16C through which the recording sheet P sent out from the sending roll 16A is transported. In addition, the plural transporting roll pairs 16B transport the recording sheet P sent out by the sending roll 16A to the secondary transfer position T1 which is a position where the driving roll 56 and the secondary transfer roll 58 oppose each other.

In addition, the reversal transporting section 16D which reverses front and rear sides of the recording sheet P and transports the recording sheet P so that the image forming may be performed on both surfaces of the recording sheet P, is provided in the transporting section 16. The reversal transporting section 16D is provided on a side opposite to the transfer unit 50 nipping the transporting path 16C when the image forming apparatus 10 is viewed from the front side. The reversal transporting section 16D switches back the recording sheet P on which the toner image is fixed on the front surface thereof. After this, the reversal transporting section 16D transports the recording sheet P to the secondary transfer position T1 so that the rear surface of the recording sheet P opposes the outer circumferential surface of the transfer belt 52.

The fixing device 18 has a function of fixing the toner image which is secondarily transferred to the recording sheet P, onto the recording sheet P. The fixing device 18 includes a fixing roll 18A and a pressure roll 18B. The fixing device 18 is disposed on the downstream side in the transporting direction of the recording sheet P with respect to the secondary transfer position T1. The fixing roll 18A is disposed on a side where the toner image is transferred on the recording sheet P, and a heating unit, such as a halogen heater (not illustrated), is disposed on an inner circumferential surface thereof. The pressure roll 18B pressurizes the recording sheet P which is transported on the transporting path 16C and passes through a position T2 that opposes the fixing roll 18A, toward the fixing roll 18A.

The discharging section 20 is formed to be closer to the downstream side than the fixing device 18 in the transporting direction of the recording sheet P, and at a part of an upper surface on the outside of a main body of the image forming section 190. The recording sheet P on which the toner image is fixed is discharged to the discharging section 20 by the exit roll 16E provided at a part between the fixing device 18 and the discharging section 20 on the transporting path 16C.

Next, an image forming operation in the image forming section 190 will be described with reference to FIG. 1.

The control section 24 operates the image forming apparatus 10 when the image signal is sent from an external apparatus (not illustrated), such as a personal computer. The control section 24 converts the image signal to image data (image information) of each color of yellow (Y), magenta (M), cyan (C), and black (K). In addition, the image data of each color is output to the exposure device 30.

Next, the exposure light emitted from the exposure device 30 in accordance with the image data of each color is incident on the outer circumferential surface of the image holding member 42 charged by the charging device 44. In addition, the latent image corresponding to the image data of each color is formed on the outer circumferential surfaces of each image holding member 42.

Furthermore, the latent image formed on the outer circumferential surfaces of each image holding member 42 is developed as the toner image of each color by each developing device 46.

In addition, the toner images of each color on the outer circumferential surfaces of each image holding member 42 is primarily transferred to the outer circumferential surface of the transfer belt 52 by each primary transfer roll 54 which is opposed by each image holding member 42.

Meanwhile, the recording sheet P is sent out from the recording sheet accommodation section 12 and transported to the secondary transfer position T1 in accordance with timing when the recording sheet P reaches the secondary transfer position T1 as apart which is the outer circumferential surface of the transfer belt 52 and to which the toner image is primarily transferred rotates. In addition, the toner image which is primarily transferred to the outer circumferential surface of the transfer belt 52 is secondarily transferred to the recording sheet P which is transported to the secondary transfer position T1 and passes through the secondary transfer position T1.

Next, the recording sheet P to which the toner image is transferred is transported toward the fixing device 18. In addition, the toner image is heated and pressurized by the fixing roll 18A and the pressure roll 18B that configure the fixing device 18, and is fixed to the recording sheet P.

The recording sheet P to which the toner image is fixed is discharged to the discharging section 20, and the image forming operation is ended.

In addition, when forming the image on both surfaces of the recording sheet P, the recording sheet P is transported to the reversal transporting section 16D after the toner image is fixed to the front surface by the fixing device 18. In addition, the recording sheet P to which the toner image is fixed on the front surface thereof is switched back by the reversal transporting section 16D. After this, the toner image is secondarily transferred to the rear surface of the recording sheet P at the secondary transfer position T1, and further, the toner image which is secondarily transferred is fixed by the fixing device 18. Lastly, the recording sheet P to which the toner image is fixed on both surfaces thereof is discharged to the discharging section 20.

Next, a developing device insertion/extraction structure 200S according to the exemplary embodiment will be described.

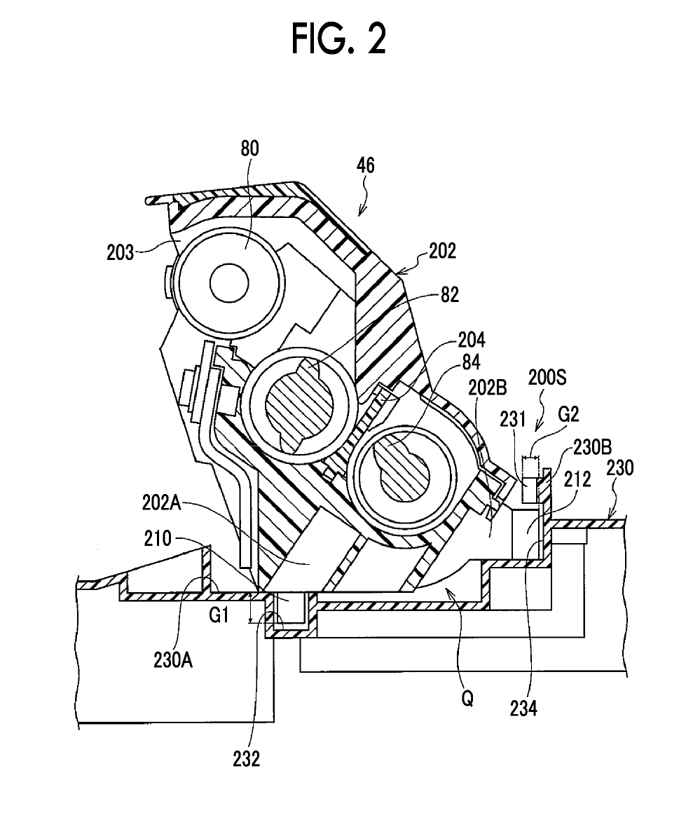

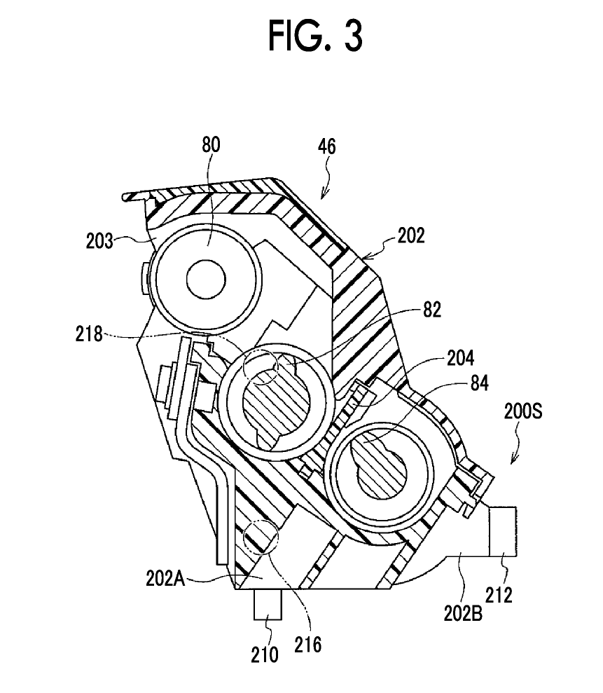

In FIG. 2, the developing device insertion/extraction structure 200S is illustrated in a side sectional view. In FIG. 3, a single unit of the developing device 46 which is used in the developing device insertion/extraction structure 200S is illustrated in a side sectional view. As illustrated in FIGS. 2 and 3, the developing device 46 includes a housing 202, and an opening portion 203 which is opened to a side opposing the image holding member 42 (refer to FIG. 1) is provided in the housing 202. In the housing 202, the roll-shaped toner supply member 80 which is disposed to face the opening portion 203 that opposes the image holding member 42, the transporting member 82 which is disposed to oppose the toner supply member 80 on a side opposite to the image holding member 42 of the toner supply member 80, and the transporting member 84 which is disposed to nip a partition section 204 at a position on a side opposite to the toner supply member 80 with respect to the transporting member 82, are provided.

The partition section 204 is disposed along the longitudinal direction in an intermediate portion (intermediate portion of the axial direction of the transporting member 82) of the longitudinal direction in the housing 202. The partition section 204 is not provided on both end portions of the longitudinal direction in the housing 202, and both end portions of the longitudinal direction in the housing 202 are opened. The transporting member 82 and the transporting member 84 which are disposed on both sides of the partition section 204 are configured to transport the developer to each other in a direction reverse to each other. Accordingly, in a space on both sides of the partition section 204, the developer is agitated and transported by the transporting member 82 and the transporting member 84, and circulates around the partition section 204.

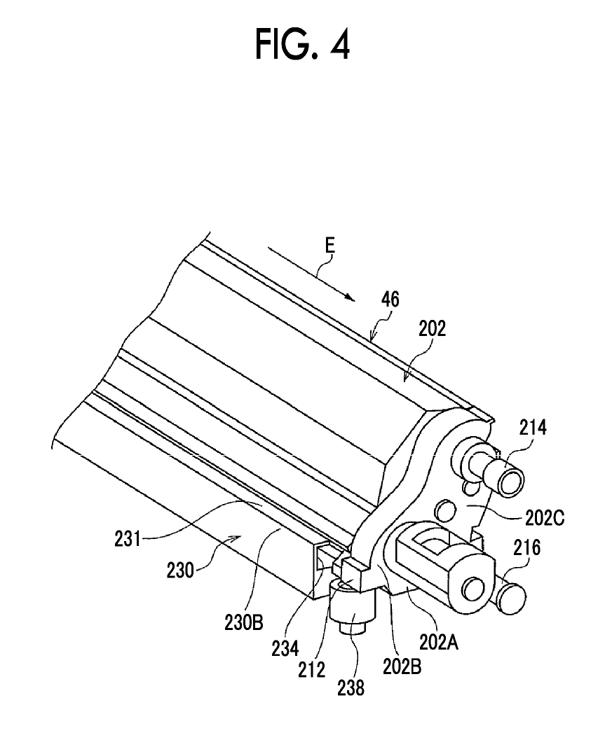

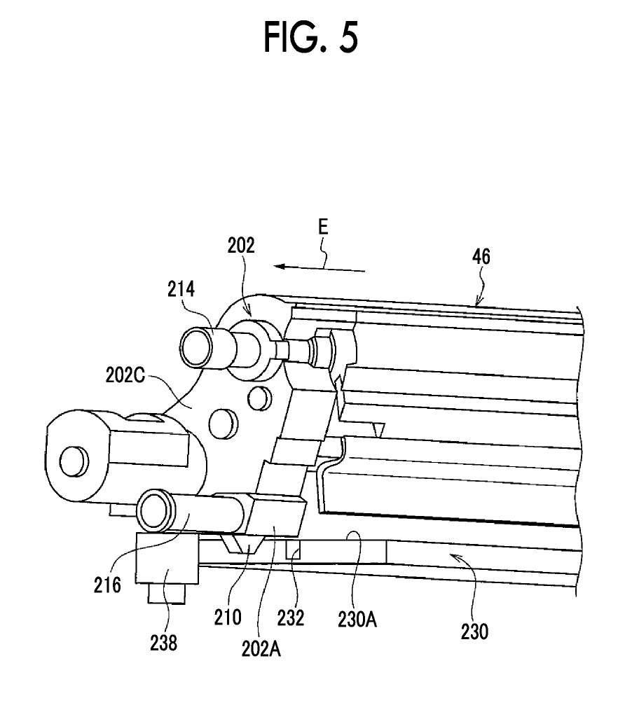

In FIG. 4, the vicinity of the tip end side in an inserting direction of the developing device 46 in which the developing device insertion/extraction structure 200S is employed is illustrated in a perspective view when viewed from obliquely above the developing device 46. In addition, in FIG. 5, the vicinity of the tip end side in the inserting direction of the developing device 46 which is used in the developing device insertion/extraction structure 200S is illustrated in a perspective view when viewed from a side of the developing device 46. As illustrated in FIGS. 2 to 5, the developing device 46 is configured to be inserted to and extracted from an image forming apparatus main body 230 which is an example of an apparatus main body along the longitudinal direction (axial direction of the toner supply member 80 or the like) of the developing device 46. In other words, the developing device 46 is configured to be inserted and extracted in the apparatus depth direction (D direction) of the image forming apparatus 10 illustrated in FIG. 1, and that is, a substantially perpendicular direction with respect to a paper surface of FIG. 2. In FIGS. 4 and 5, the inserting direction with respect to the image forming apparatus main body 230 of the developing device 46 is an arrow E direction along the longitudinal direction of the developing device 46.

As illustrated in FIGS. 2 to 5, in the developing device insertion/extraction structure 200S, a first convex portion 210 which is an example of a first restriction target section which protrudes downward in a convex shape, is provided in a bottom surface portion 202A which is an example of the housing 202 of the developing device 46. In addition, in the developing device insertion/extraction structure 200S, a second convex portion 212 which is an example of a second restriction target section which protrudes sideways in a convex shape, is provided in a side portion 202B (in the exemplary embodiment, the side portion 202B on a lower side of the housing 202 on a side opposite to the toner supply member 80) of the housing 202 of the developing device 46.

The image forming apparatus main body 230 has a supporting surface 230A which supports the bottom surface portion 202A to be slidable when the developing device 46 is inserted and extracted, at a position opposing the bottom surface portion 202A of the developing device 46 (refer to FIGS. 2 and 5). In the developing device insertion/extraction structure 200S, a first concave portion 232 which is an example of the first restriction target section recessed downward in a concave shape is provided so that the first convex portion 210 of the developing device 46 is input (inserted) according to the insertion and extraction of the developing device 46, on the supporting surface 230A of the image forming apparatus main body 230 (refer to FIGS. 2 and 5). As the first convex portion 210 is input (inserted), the first concave portion 232 is configured to restrict the displacement of the first convex portion 210 in the horizontal direction which is orthogonal to the longitudinal direction of the developing device 46, according to the insertion or extraction of the developing device 46. In the first concave portion 232 and the first convex portion 210, in a state where the first convex portion 210 is input to the first concave portion 232, a gap is formed between an inner wall surface of the first concave portion 232 and an outer wall surface of the first convex portion 210 so that the insertion and the extraction of the developing device 46 to and from the image forming apparatus main body 230 are possible.

In addition, the image forming apparatus main body 230 has a side wall portion 230B at a position opposing the side portion 202B of the developing device 46 (refer to FIGS. 2 and 4). In the side wall portion 230B of the image forming apparatus main body 230, a second concave portion 234 which is an example of a second restriction target section that is recessed sideways in a concave portion is provided so that the second convex portion 212 of the developing device 46 is input (inserted) according to the insertion and the extraction of the developing device 46 (refer to FIGS. 2 and 4). In the side wall portion 230B of the image forming apparatus main body 230, an eaves section 231 which protrudes on the developing device 46 side and configures an upper edge wall portion of the second concave portion 234, is provided above the second concave portion 234 (refer to FIGS. 2, 4, and 7). The second concave portion 234 is configured to restrict the displacement of the second convex portion 212 in a vertical direction which is orthogonal to the longitudinal direction of the developing device 46 according to the insertion or the extraction of the developing device 46, as the second convex portion 212 is input (inserted). In the second concave portion 234 and the second convex portion 212, in a state where the second convex portion 212 is input to the second concave portion 234, a gap is formed between an inner wall surface of the second concave portion 234 and an outer wall surface of the second convex portion 212 so that the insertion and the extraction of the developing device 46 to and from the image forming apparatus main body 230 are possible.

In other words, when the developing device 46 is inserted to and sent out from the image forming apparatus main body 230, the first convex portion 210 is guided from the first concave portion 232, and the second convex portion 212 is guided from the second concave portion 234.

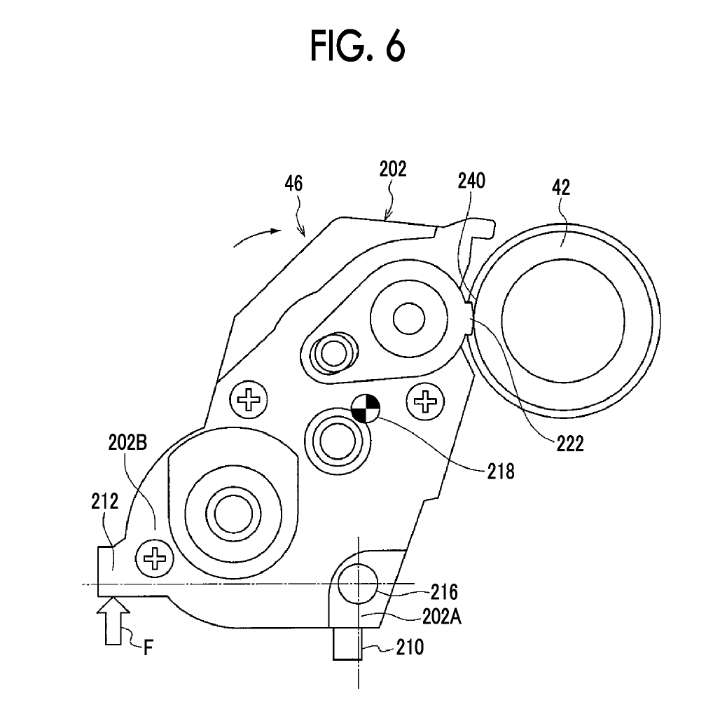

As illustrated in FIGS. 4 and 5, in the developing device 46, an extending axis section 214 which extends to an end portion side in the axial direction of the toner supply member 80 is provided in a side surface portion 202C which is an example of a surface on the tip end side in the inserting direction of the housing 202 illustrated by the arrow E, is provided. In the developing device 46, a driving force for rotating the toner supply member 80 from the extending axis section 214 is input. In addition, in the side surface portion 202C of the developing device 46, a positioning axis 216 which protrudes along the longitudinal direction of the developing device 46 from the side surface portion 202C is provided. When viewed from the direction of the side surface portion 202C of the developing device 46, the positioning axis 216 is provided on a lower side of the side surface portion 202C, that is, on the toner supply member 80 side in the direction which is orthogonal to the longitudinal direction of the developing device 46. More specifically, as illustrated in FIGS. 3 and 6, when viewed from the direction of the side surface portion 202C of the developing device 46, the positioning axis 216 is provided below a center of gravity 218 of the developing device 46. Here, the center of gravity 218 of the developing device 46 illustrates a center of gravity portion in a state where the developer is input to the developing device 46.

When insertion of the developing device 46 to the image forming apparatus main body 230 in the arrow E direction is completed, as the positioning axis 216 is fitted to a concave portion (not illustrated) provided in the image forming apparatus main body 230, the developing device 46 is positioned in the horizontal direction orthogonal to the inserting direction with respect to the image forming apparatus main body 230 and in the vertical direction orthogonal to the inserting direction. In a state where the positioning axis 216 is fitted to the concave portion (not illustrated) of the image forming apparatus main body 230, the developing device 46 is allowed to rotate with respect to the image forming apparatus main body 230 around the positioning axis 216.

As illustrated in FIG. 4, the second convex portion 212 is provided at a position on the tip end side in the inserting direction (arrow E direction) in the side portion 202B of the housing 202 of the developing device 46. In other words, the second convex portion 212 is not provided on the entire surface in the longitudinal direction of the side portion 202B of the housing 202, and is provided only on the tip end side in the inserting direction in the side portion 202B.

In addition, the second concave portion 234 is provided on substantially the entire surface of the inserting direction, along the inserting direction of the developing device 46 illustrated by the arrow E, in the side wall portion 230B of the image forming apparatus main body 230, but is not provided in the vicinity of the tip end portion of the inserting direction of the developing device 46. Accordingly, in the middle of the insertion of the developing device 46, the second convex portion 212 of the developing device 46 is inserted to the second concave portion 234 of the image forming apparatus main body 230. In addition, when the insertion of the developing device 46 to the image forming apparatus main body 230 in the arrow E direction is completed, the second convex portion 212 of the developing device 46 is disengaged (comes out) from the second concave portion 234 of the image forming apparatus main body 230 (refer to FIG. 4).

As illustrated in FIG. 5, the first convex portion 210 is provided at a position on the tip end side in the inserting direction (arrow E direction) in the bottom surface portion 202A of the housing 202 of the developing device 46. In other words, the first convex portion 210 is not provided on the entire surface in the longitudinal direction of the bottom surface portion 202A of the housing 202, and is provided only on the tip end side in the inserting direction in the bottom surface portion 202A. The first convex portion 210 has a shape which protrudes in a shape of a substantial trapezoid when viewed from the direction orthogonal to the longitudinal direction (inserting direction illustrated by the arrow E) of the developing device 46. More specifically, both end portions in the inserting direction of the first convex portion 210 are inclined surfaces which have uphill grades toward an upper side from a lower side. Accordingly, the first convex portion 210 is likely to be inserted to the first concave portion 232.

In addition, the first concave portion 232 is provided on substantially the entire length of the inserting direction, along the inserting direction of the developing device 46 illustrated by the arrow E, on the supporting surface 230A of the image forming apparatus main body 230, but is not provided in the vicinity of the tip end portion in the inserting direction of the developing device 46. Accordingly, in the middle of the insertion of the developing device 46, the first convex portion 210 of the developing device 46 is inserted to the first concave portion 232 of the image forming apparatus main body 230. In addition, when the insertion of the developing device 46 to the image forming apparatus main body 230 in the arrow E direction is completed, the first convex portion 210 of the developing device 46 is disengaged (comes out) from the first concave portion 232 of the image forming apparatus main body 230 (refer to FIG. 5).

In addition, as illustrated in FIGS. 3 and 6, in the developing device 46, when viewed from the inserting direction (direction of the side surface portion 202C) of the developing device 46, protruding directions of the first convex portion 210 and the second convex portion 212 with respect to the positioning axis 216 are substantially orthogonal to each other. At this time, the protruding positions of the first convex portion 210 and the second convex portion 212 may overlap in a direction which is substantially orthogonal to the positioning axis 216 (refer to FIG. 6). In other words, the position of the center in the protruding directions of the first convex portion 210 and the second convex portion 212 may not match the direction which is substantially orthogonal to the positioning axis 216 (may not be positioned in substantially the orthogonal direction).

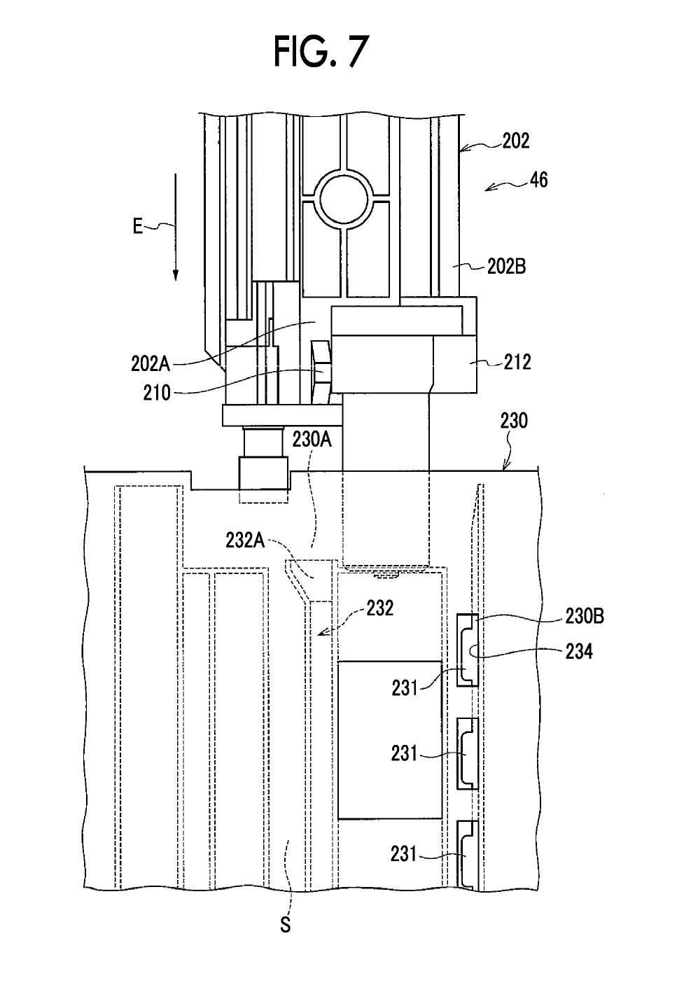

In FIGS. 7 to 9, a process of inserting the developing device 46 to the image forming apparatus main body 230 is illustrated in bottom views when the developing device 46 is viewed from below. As illustrated in FIGS. 7 to 9, the developing device 46 is inserted to a space portion S provided in the image forming apparatus main body 230 in the arrow E direction. An insertion position as an example of a restricted position of the first convex portion 210 and the first concave portion 232, and an insertion position which is an example of a restricted position of the second convex portion 212 and the second concave portion 234, are different from each other in the longitudinal direction on the insertion side in the inserting direction of the developing device 46. More specifically, as illustrated in FIGS. 7 to 9, in the inserting direction illustrated by the arrow E of the developing device 46 to the image forming apparatus main body 230, the first convex portion 210 and the second convex portion 212 overlap each other in the inserting direction of the developing device 46 when viewed from a lower surface of the developing device 46, but the first convex portion 210 is provided to be slightly closer than the second convex portion 212 to the tip end side in the inserting direction of the developing device 46.

In addition, in the inserting direction illustrated by the arrow E of the developing device 46 to the image forming apparatus main body 230, the first concave portion 232 and the second concave portion 234 of the image forming apparatus main body 230 overlap each other in the inserting direction of the developing device 46, but the first concave portion 232 extends to be closer than the second concave portion 234 to the tip end side in the inserting direction (refer to the position of the eaves section 231). A part 232A on a near side in the inserting direction of the first concave portion 232 is formed so that the width (width of a vertical wall surface which opposes the first concave portion 232) toward the closer side in the inserting direction of the first convex portion 210 gradually widens to make it easy for the first convex portion 210 to be inserted (to guide the first convex portion 210).

As illustrated in FIGS. 4 and 5, when the insertion of the developing device 46 to the image forming apparatus main body 230 is completed, after the second convex portion 212 of the developing device 46 is disengaged from the second concave portion 234 of the image forming apparatus main body 230, the developing device 46 is pressed to the image holding member 42 of the image forming apparatus main body 230 by a load of a spring member 238 which acts on the second convex portion 212.

As illustrated in FIG. 6, when the insertion of the developing device 46 to the image forming apparatus main body 230 in the arrow E direction (refer to FIG. 4 or the like) is completed, the positioning axis 216 is fitted to a concave portion (not illustrated) provided in the image forming apparatus main body 230. In this state, as the second convex portion 212 of the developing device 46 is pressed in an arrow F direction by the load of the spring member 238 (refer to FIG. 4 or the like), the developing device 46 rotates in the direction of the image holding member 42 of the image forming apparatus main body 230 around the positioning axis 216, and the developing device 46 is pressed to the image holding member 42. More specifically, a protruded portion 222 provided in both end portions in the axial direction of the toner supply member 80 of the developing device 46 comes into contact with a contact portion 240 provided in both end portions in the axial direction of the image holding member 42, and the contact of the developing device 46 to the image holding member 42 is completed.

Next, operations and effects of the developing device insertion/extraction structure 200S according to the exemplary embodiment will be described.

The developing device 46 is inserted to or extracted from the image forming apparatus main body 230 along the longitudinal direction of the developing device 46. The developing device 46 is inserted to the image forming apparatus main body 230 in the arrow E direction along the longitudinal direction of the developing device 46 (refer to FIGS. 4 and 5). In the developing device insertion/extraction structure 200S, the first convex portion 210 which protrudes downward is provided in the bottom surface portion 202A of the housing 202 of the developing device 46, and the second convex portion 212 which protrudes sideways is provided in the side portion 202B of the housing 202 of the developing device 46 (refer to FIGS. 2 to 5).

In addition, in the developing device insertion/extraction structure 200S, the first concave portion 232 to which the first convex portion 210 of the developing device 46 is input (inserted) according to the insertion and the extraction of the developing device 46 is provided on the supporting surface 230A of the image forming apparatus main body 230 (refer to FIGS. 2 to 5). Furthermore, the second concave portion 234 to which the second convex portion 212 of the developing device 46 is input (inserted) according to the insertion and the extraction of the developing device 46 is provided in the side wall portion 230B of the image forming apparatus main body 230 (refer to FIGS. 2 and 4).

In the developing device insertion/extraction structure 200S, as the first convex portion 210 of the image forming apparatus main body 230 is inserted to the first concave portion 232 of the developing device 46 according to the insertion or the extraction of the developing device 46, the displacement of the first convex portion 210 in the horizontal direction which is orthogonal to the longitudinal direction of the developing device 46 is restricted. Furthermore, in the developing device insertion/extraction structure 200S, as the second convex portion 212 of the image forming apparatus main body 230 is inserted to the second concave portion 234 of the developing device 46 according to the insertion or the extraction of the developing device 46, the displacement of the second convex portion 212 in the vertical direction which is orthogonal to the longitudinal direction of the developing device 46 is restricted.

In addition, as illustrated in FIGS. 7 to 9, in the developing device insertion/extraction structure 200S, an insertion position of the first convex portion 210 and the first concave portion 232, and an insertion position of the second convex portion 212 and the second concave portion 234, are different from each other in the longitudinal direction on the insertion side in the inserting direction of the developing device 46. More specifically, as illustrated in FIGS. 7 to 9, in the inserting direction illustrated by the arrow E of the developing device 46 to the image forming apparatus main body 230, the first convex portion 210 and the second convex portion 212 overlap each other in the inserting direction of the developing device 46 when viewed from a lower surface of the developing device 46, but the first convex portion 210 is provided to be slightly closer than the second convex portion 212 to the tip end side in the inserting direction of the developing device 46. In addition, in the inserting direction illustrated by the arrow E of the developing device 46 to the image forming apparatus main body 230, the first concave portion 232 and the second concave portion 234 of the image forming apparatus main body 230 overlap each other in the inserting direction of the developing device 46, but the first concave portion 232 extends to be closer than the second concave portion 234 to the near side in the inserting direction. The part 232A on a near side in the inserting direction of the first concave portion 232 is formed so that the width (width of the vertical wall surface which opposes the first concave portion 232) toward the near side in the inserting direction of the first convex portion 210 gradually widens, and the first convex portion 210 is likely to be inserted to the first concave portion 232.

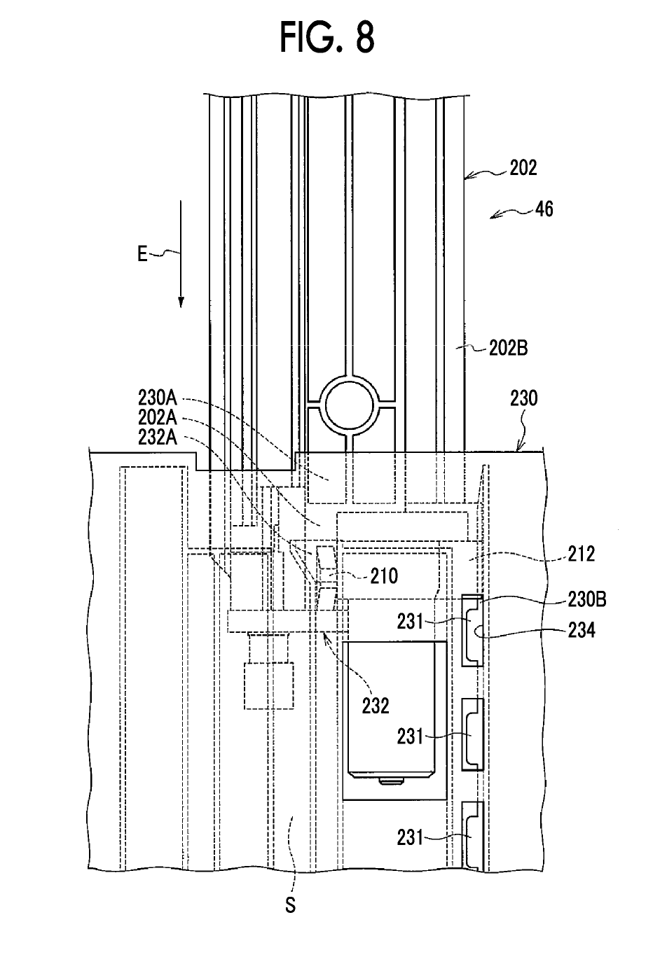

In the developing device insertion/extraction structure 200S, as illustrated in FIG. 7, the developing device 46 is inserted to the space portion S of the image forming apparatus main body 230 in the arrow E direction. When the insertion of the developing device 46 to the space portion S of the image forming apparatus main body 230 is initiated, as illustrated in FIG. 8, first, the first convex portion 210 provided in the bottom surface portion 202A of the developing device 46 is input (inserted) to the first concave portion 232 provided on the supporting surface 230A of the image forming apparatus main body 230. At this time, the bottom surface portion 202A of the developing device 46 comes into contact with the supporting surface 230A of the image forming apparatus main body 230, and the bottom surface portion 202A is inserted in the arrow E direction while sliding on the supporting surface 230A. In this state, as the first convex portion 210 is input (inserted) to the first concave portion 232, the displacement of the first convex portion 210 in the horizontal direction which is orthogonal to the longitudinal direction of the developing device 46 is restricted.

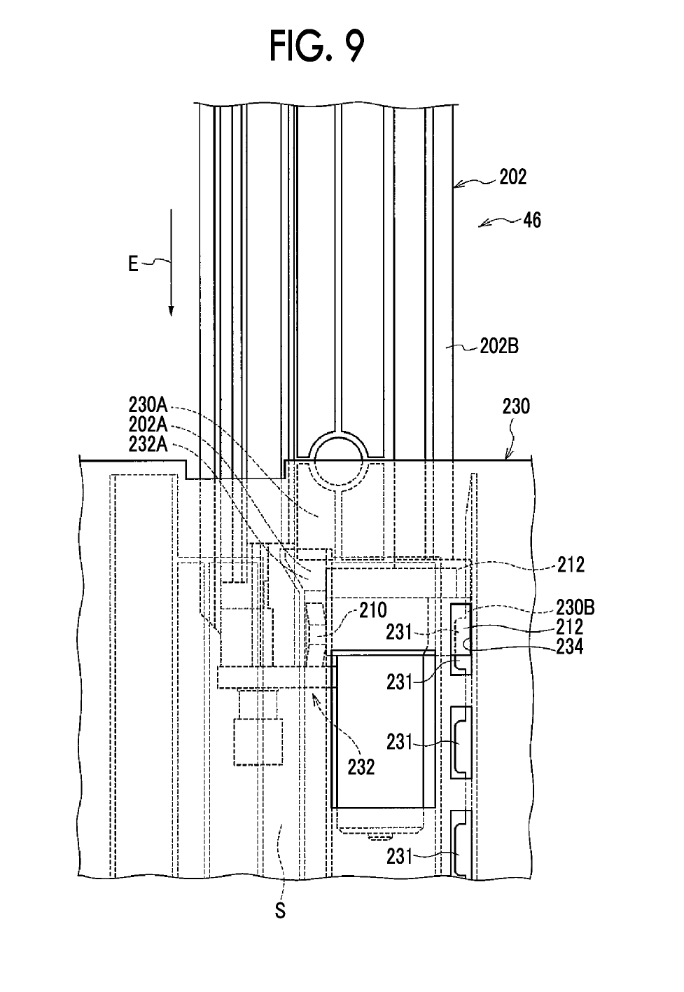

After this, as illustrated in FIG. 9, when further inserting the developing device 46 to the space portion S of the image forming apparatus main body 230, the second convex portion 212 provided in the side portion 202B of the developing device 46 is input (inserted) to the second concave portion 234 provided in the side wall portion 230B of the image forming apparatus main body 230. In this state, the displacement of the second convex portion 212 in the vertical direction which is orthogonal to the longitudinal direction of the developing device 46 is restricted. In the developing device 46, as the second convex portion 212 is supported by the second concave portion 234, a gap Q (refer to FIG. 2) is generated between a bottom surface of the developing device 46 and the image forming apparatus main body 230. When the developing device 46 is inserted to the image forming apparatus main body 230, the entire bottom surface of the developing device 46 does not come into contact with the image forming apparatus main body 230, and only the bottom surface portion 202A immediately below the positioning axis 216 comes into contact with the supporting surface 230A. In this configuration, frictional resistance during the insertion is reduced compared to a case where the entire bottom surface of the developing device 46 comes into contact with the image forming apparatus main body 230.

Similarly, the frictional resistance during the extraction of the developing device 46 is reduced compared to a case where the entire bottom surface of the developing device 46 comes into contact with the image forming apparatus main body 230.

In addition, as illustrated in FIGS. 3 and 6, in the developing device insertion/extraction structure 200S, the positioning axis 216 is provided below the center of gravity 218 of the developing device 46 in the side surface portion 202C on the tip end side in the inserting direction of the developing device 46. In addition, in the developing device 46, the protruding directions of the first convex portion 210 and the second convex portion 212 with respect to positioning axis 216 are substantially orthogonal to each other.

In addition, as illustrated in FIGS. 4 and 5, in the developing device insertion/extraction structure 200S, when the insertion of the developing device 46 to the image forming apparatus main body 230 is completed, after the second convex portion 212 of the developing device 46 is disengaged from the second concave portion 234 of the image forming apparatus main body 230, the developing device 46 is pressed to the image holding member 42 of the image forming apparatus main body 230 by the load of the spring member 238 which acts on the second convex portion 212.

As described above, in the developing device insertion/extraction structure 200S, the first convex portion 210 is provided in the bottom surface portion 202A of the housing 202 of the developing device 46, and the second convex portion 212 is provided in the side portion 202B of the housing 202 of the developing device 46. In addition, the first concave portion 232 to which the first convex portion 210 is input (inserted) according to the insertion and the extraction of the developing device 46 is provided on the supporting surface 230A of the image forming apparatus main body 230, and the second concave portion 234 to which the second convex portion 212 is input (inserted) according to the insertion and the extraction of the developing device 46 is provided in the side wall portion 230B of the image forming apparatus main body 230. For this reason, the developing device insertion/extraction structure 200S and the image forming apparatus 10 in which the displacement of the developing device 46 is suppressed in the vertical direction to be small while maintaining stability of the developing device 46 in the horizontal direction when inserting the developing device 46 to the image forming apparatus main body 230, are provided, compared to a configuration in which a groove portion which is fitted to a guide projection of the apparatus main body is provided only in the bottom surface portion of the developing device.

In addition, in the developing device insertion/extraction structure 200S, the insertion position of the first convex portion 210 and the first concave portion 232, and the insertion position of the second convex portion 212 and the second concave portion 234, are different from each other in the longitudinal direction on the insertion side of the developing device 46. For this reason, in the developing device insertion/extraction structure 200S, the insertion of the first convex portion 210 to the first concave portion 232, and the insertion of the second convex portion 212 to the second concave portion 234 become easier compared to a configuration in which a restriction position of the first restriction target section and the first restricting section, and a restriction position of the second restriction target section and the second restricting section, are equivalent to each other in the longitudinal direction on the insertion side of the developing device. For this reason, the insertion work of the developing device 46 to the image forming apparatus main body 230 becomes easy.

In addition, in the developing device insertion/extraction structure 200S, in the side surface portion 202C on the tip end side in the inserting direction of the developing device 46, the positioning axis 216 is provided below the center of gravity 218 of the developing device 46, and the protruding directions of the first convex portion 210 and the second convex portion 212 with respect to the positioning axis 216 are substantially orthogonal to each other. For this reason, in the developing device insertion/extraction structure 2005, compared to a case where the protruding directions of the first restriction target section and the second restriction target section with respect to the positioning axis are not orthogonal to each other, a lapped amount (superposed amount) between the first convex portion 210 and the first concave portion 232, and between the second convex portion 212 and the second concave portion 234 may be restricted to be small as illustrated by arrows G1 and G2, and the size of the developing device 46 may be reduced.

In addition, in the developing device insertion/extraction structure 200S, when the developing device 46 is inserted to the image forming apparatus main body 230, after the second convex portion 212 of the developing device 46 is disengaged from the second concave portion 234 of the image forming apparatus main body 230, the developing device 46 is pressed to the image holding member 42 of the image forming apparatus main body 230 by the load of the spring member 238 which acts on the second convex portion 212. For this reason, the developing device insertion/extraction structure 200S in which the developing device 46 is pressed to the image holding member 42 by a small load is provided, compared to a configuration in which the developing device is not pressed to the image holding member by the load which acts on the second restriction target section after the second restriction target section is disengaged from the second restricting section when the developing device is inserted to the apparatus main body.

In addition, in the above-described exemplary embodiment, the first convex portion 210 is provided in the bottom surface portion 202A of the housing 202 of the developing device 46, and the second convex portion 212 is provided in the side portion 202B of the housing 202 of the developing device 46, but the present invention is not limited to the configuration. In addition, the size and the shape of the first convex portion 210 are not limited to the above-described exemplary embodiment, and may be changed. The size and the shape of the second convex portion 212 are not limited to the above-described exemplary embodiment, and may be changed. In addition, in the above-described exemplary embodiment, the first concave portion 232 to which the first convex portion 210 is inserted is provided on the supporting surface 230A of the image forming apparatus main body 230, and the second concave portion 234 to which the second convex portion 212 is inserted is provided in the side wall portion 230B of the image forming apparatus main body 230, but the present invention is not limited to the configuration. In addition, the size and the shape of the first concave portion 232 are not limited to the above-described exemplary embodiment, and may be changed. The size and the shape of the second concave portion 234 are not limited to the above-described exemplary embodiment, and may be changed.

For example, one of the first restriction target section on the lower portion of the developing device and the second restriction target section of the side portion of the developing device may have a convex shape, the other one of the first restriction target section on the lower portion of the developing device and the second restriction target section of the side portion of the developing device may have a concave shape, and the first restricting section and the second restricting section of the image forming apparatus may have a shape (a concave shape or a convex shape) which corresponds to the shapes of the restriction target sections. In addition, both the first restriction target section of the lower portion of the developing device and the second restriction target section of the side portion of the developing device may have a concave shape, and both the first restricting section and the second restricting section of the image forming apparatus may have a convex shape.

In addition, in the above-described embodiment, when the developing device 46 is inserted to the image forming apparatus main body 230, first, the first convex portion 210 is inserted to the first concave portion 232, and then, the second convex portion 212 is inserted to the second concave portion 234, but the present invention is not limited to the configuration. For example, a configuration in which, when the developing device 46 is inserted to the image forming apparatus main body 230, first, the second restriction target section is restricted by the second restricting section, and then, the first restriction target section is restricted by the first restricting section, may be employed. In addition, on the insertion side of the developing device 46 to the image forming apparatus main body 230, the position where the first restriction target section is restricted by the first restricting section, and the position where the second restriction target section is restricted by the second restricting section, are substantially the same as each other in the inserting direction of the developing device 46.

In addition, in the above-described exemplary embodiment, in the side surface portion 202C on the tip end side in the inserting direction of the developing device 46, the positioning axis 216 is provided below the center of gravity 218 of the developing device 46, and the protruding directions of the first convex portion 210 and the second convex portion 212 with respect to the positioning axis 216 are substantially orthogonal to each other, but the present invention is not limited to the configuration. For example, the protruding directions of the first convex portion and the second convex portion with respect to the positioning axis 216 may intersect each other.

In addition, the present invention is described in detail by using a specific exemplary embodiment, but the present invention is not limited to the exemplary embodiment, and it is apparent to those skilled in the art that other various exemplary embodiments may be within the range of the present invention.

In addition, in the “developing device” in which the developing device insertion/extraction structure of the present invention is employed, for example, a cartridge which is formed to be attachable to and detachable from the image forming apparatus main body, and includes the developing device 46 and other members (for example, the image holding member 42 or the like) is included.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A developing device insertion/extraction structure, comprising:
a developing device that is inserted to and extracted from an apparatus main body along a longitudinal direction, and includes a first restriction target section formed on a lower portion and a second restriction target section formed on a side portion;
a first restricting section that is formed in the apparatus main body, and restricts displacement of the first restriction target section in a horizontal direction orthogonal to the longitudinal direction according to insertion or extraction of the developing device with respect to the apparatus main body, wherein a part on a near side in an inserting direction of the first restricting section has a width of a vertical wall surface that opposes the first restricting section toward the closer side in the inserting direction of the first restriction target section and that gradually widens; and
a second restricting section that is formed in the apparatus main body, and restricts displacement of the second restriction target section in a vertical direction orthogonal to the longitudinal direction according to the insertion or the extraction of the developing device with respect to the apparatus main body.

2. The developing device insertion/extraction structure according to claim 1,
wherein a restriction position of the first restriction target section and the first restricting section, and a restriction position of the second restriction target section and the second restricting section, are different from each other in the longitudinal direction on the insertion side of the developing device.

3. The developing device insertion/extraction structure according to claim 1,
wherein a positioning axis is provided below a center of gravity of the developing device, and on a surface on a tip end side in the inserting direction of the developing device, and
wherein protruding directions of the first restriction target section and the second restriction target section with respect to the positioning axis are orthogonal to each other.

4. The developing device insertion/extraction structure according to claim 2,
wherein a positioning axis is provided below a center of gravity of the developing device, and on a surface on a tip end side in the inserting direction of the developing device, and
wherein protruding directions of the first restriction target section and the second restriction target section with respect to the positioning axis are orthogonal to each other.

5. The developing device insertion/extraction structure according to claim 1,
wherein the second restriction target section has a concave shape and the second restricting section has a convex shape, and
wherein, after the second restriction target section is disengaged from the second restricting section when the developing device is inserted to the apparatus main body, the developing device is pressed to an image holding member provided in the apparatus main body by a load which acts on the second restriction target section.

6. The developing device insertion/extraction structure according to claim 2,
wherein the second restriction target section has a concave shape and the second restricting section has a convex shape, and
wherein, after the second restriction target section is disengaged from the second restricting section when the developing device is inserted to the apparatus main body, the developing device is pressed to an image holding member provided in the apparatus main body by a load which acts on the second restriction target section.

7. The developing device insertion/extraction structure according to claim 3,
wherein the second restriction target section has a concave shape and the second restricting section has a convex shape, and
wherein, after the second restriction target section is disengaged from the second restricting section when the developing device is inserted to the apparatus main body, the developing device is pressed to an image holding member provided in the apparatus main body by a load which acts on the second restriction target section.

8. The developing device insertion/extraction structure according to claim 4,
wherein the second restriction target section has a concave shape and the second restricting section has a convex shape, and
wherein, after the second restriction target section is disengaged from the second restricting section when the developing device is inserted to the apparatus main body, the developing device is pressed to an image holding member provided in the apparatus main body by a load which acts on the second restriction target section.

9. The developing device insertion/extraction structure according to claim 1,
wherein, when the developing device is inserted and extracted while the second restriction target section is restricted by the second restricting section, a gap is generated between a bottom surface of the developing device and the apparatus main body.

10. The developing device insertion/extraction structure according to claim 2,
wherein, when the developing device is inserted and extracted while the second restriction target section is restricted by the second restricting section, a gap is generated between a bottom surface of the developing device and the apparatus main body.

11. The developing device insertion/extraction structure according to claim 3,
wherein, when the developing device is inserted and extracted while the second restriction target section is restricted by the second restricting section, a gap is generated between a bottom surface of the developing device and the apparatus main body.

12. The developing device insertion/extraction structure according to claim 4,
wherein, when the developing device is inserted and extracted while the second restriction target section is restricted by the second restricting section, a gap is generated between a bottom surface of the developing device and the apparatus main body.

13. The developing device insertion/extraction structure according to claim 5,
wherein, when the developing device is inserted and extracted while the second restriction target section is restricted by the second restricting section, a gap is generated between a bottom surface of the developing device and the apparatus main body.

14. The developing device insertion/extraction structure according to claim 6,
wherein, when the developing device is inserted and extracted while the second restriction target section is restricted by the second restricting section, a gap is generated between a bottom surface of the developing device and the apparatus main body.

15. The developing device insertion/extraction structure according to claim 7,
wherein, when the developing device is inserted and extracted while the second restriction target section is restricted by the second restricting section, a gap is generated between a bottom surface of the developing device and the apparatus main body.

16. The developing device insertion/extraction structure according to claim 8,
wherein, when the developing device is inserted and extracted while the second restriction target section is restricted by the second restricting section, a gap is generated between a bottom surface of the developing device and the apparatus main body.

17. An image forming apparatus, having:
the developing device insertion/extraction structure according to claim 1.

18. An image forming apparatus, having:
the developing device insertion/extraction structure according to claim 2.

19. A developing device insertion/extraction structure, comprising:
a developing device that is inserted to and extracted from an apparatus main body along a longitudinal direction, and includes a first restriction target section formed on a lower portion and a second restriction target section formed on a side portion, wherein at least a tip end side portion in an inserting direction of the first restriction target section are inclined surfaces which have uphill grades toward and upper side from a lower side;
a first restricting section that is formed in the apparatus main body, and restricts displacement of the first restriction target section in a horizontal direction orthogonal to the longitudinal direction according to insertion or extraction of the developing device with respect to the apparatus main body; and
a second restricting section that is formed in the apparatus main body, and restricts displacement of the second restriction target section in a vertical direction orthogonal to the longitudinal direction according to the insertion or the extraction of the developing device with respect to the apparatus main body.
